(19) United States
(12) Patent Application Publication
(10) Pub. No.: US 2002/0151994 A1
(43) Pub. Date: Oct. 17, 2002

(54) Methods and apparatus for providing information on the game of golf

(76) Inventor: Kent Sisco, Lynden, WA (US)

Correspondence Address: MILLER NASH LLP, 4400 TWO UNION SQUARE, 601 UNION STREET, SEATTLE, WA, 98101-2352, US

(21) Appl. No.: 10/167,722

(22) Filed: Jun. 12, 2002

Related U.S. Application Data
(63) Continuation-in-part of application No. 09/595,757, filed on Jun. 16, 2000.

(51) Int. Cl. G06F 155/00

(52) U.S. Cl. 700/91

(57) ABSTRACT

Portable, self-contained, hand-held or golf cart-mounted instrumentalities which use single-entry or recordkeeping to track a golfer's play of the game. Data can be entered by displaying a layout of a hole and pointing to locations on the layout which correspond to actual positions on the hole being played. The golfer interacts with the instrumentality via an interface composed of a view, an iconbar, and dialogs. Strokes are recorded for each hole by employing: hole selection, teebox dialog, ball position settings, club and flight dialog, and putting dialog.

### CROSS-REFERENCE TO RELATED APPLICATION

This application is a continuation-in-part of U.S. patent application Ser. No. 09/595,757, filed Jun. 16, 2000. The benefit of the filing date of that application is hereby claimed. The disclosure of U.S. patent application Ser. No. 09/595,757 is hereby incorporated herein by reference.

### TECHNICAL FIELD OF THE INVENTION

The present invention relates to novel, improved methods and apparatus for making information on one or more golfer's play available to a golfer playing a round of golf or after the round has been completed.

### BACKGROUND OF THE INVENTION

Golf is, to a significant extent, a game of numbers and other information. A golfer needs, or finds it advantageous, to know how far it is from the tee (or lie of the ball) to the pin (or at least the center of the green for each hole he plays) as well as the layout of the hole, the distance to and nature of hazards and boundaries, and other information on the hole being played. In most cases, the golfer will also want to record his score—and the scores of his golfing companions—and to compare his current with his past performances on the same and for other courses. The accumulation of data on side games such as skins, medal play, Stableford, etc., may also be desired as may a detailed breakdown of a player's round. The following is a typical list of items for which a golfer might wish to accumulate data in the course of a round for subsequent review:

Greens in regulation

Fairways hit

Sand saves

Greenside bunkers

Penalty strokes

Eagles

Birdies

Pars

Bogeys

Double Bogeys

Triple Bogeys or more

Zero putts (chip-ins)

One putts

Two putts

Three putts or more

Varied approaches to the supply of the foregoing and other information have been devised over the years.

Many course operators provide maps, usually as part of a score card, which illustrate the layout of the course and which indicate the distance from the tee to the flag for each hole. Additionally, courses usually include distance markers at locations along each fairway.

A variety of devices for measuring the distance between the golfer and the flag (or other feature of a hole) have also been proposed. Some of these devices utilize methods to perform distance measurement which require visual sighting of the flag, while others use the flag to support a signal receiver or transmitter. Other prior art systems rely on a coordinate system of the golf course and use linear accelerometers to track a golfer's movement along the course. Yet other systems use tracking sensors installed below the fairway turf.

Still other systems, rapidly proliferating in numbers, utilize the Global Positioning System (“GPS”) for locating a player on a golf course and then calculating the distance from that location to, typically, the pin of the hole the golfer is playing.

There are a number of drawbacks to the above-discussed arrangements for providing information to a player while he is on the course. The score cards on which course maps are printed only accommodate a map three by five inches in size. With all 18 holes being displayed in an area this size, details of interest to the golfer are omitted. These maps generally fail to identify hazards such as water and sand traps. Even when a course map depicts hazards, it virtually never provides distances to those hazards, nor does it typically provide other important distances, such as to the front of the green or to the back of the green. Maps are often not up-to-date. As a golf season progresses, courses can become worn from over-use. Consequently, course operators periodically relocate the tees and the flags. As a result, the distance information provided by the maps is often inaccurate.

Another significant drawback of golf location systems that utilize a score card and accompanying map is that it is difficult for a golfer to track his round-by-round play at a particular course or overall. Accordingly, unless a golfer takes notes and saves old score cards, it is virtually impossible for the golfer to evaluate his performance over time.

Yardage books have been said to be an improvement over posted signs and scorecard maps. However, yardage books do not provide the distance to the actual pin location. These books are cumbersome and, as the information in the book is complex in an attempt to be complete, the relevant information is often not readily available, particularly to a tyro golfer. Finally, yardage books typically do not provide distances from locations within 100 yards of a green.

Relocation of tees and pins also makes distance markers inaccurate. A further disadvantage of distance markers is that they are sometimes difficult to locate. Often, hard to distinguish shrubs are used as distance markers. At other golf courses, small stakes are located along the edge of the fairway. At still other courses, small metal or cement plates are placed in the ground. These distance markers are usually of little value to those who may need them the most. Furthermore, distance markers, like yardage books, do not provide distances from locations within 100 yards of a green.

More automated systems also have their drawbacks. A not always available line of sight view of the flag may be required; and this problem is compounded if golfers playing ahead forget to replace the flag after playing a hole. Those systems requiring the installation of sensors and other devices are invariably expensive to install and to service. Systems such as those employing LORAN, for example, are susceptible to electronic noise, especially that in the radio frequency range. Even electric golf carts can generate electronic noise that will adversely affect, to a significant degree, the accuracy of a LORAN system.

LORAN, GPS, and other electronic ranging devices also slow play, in part due to signal loss. This is frustrating to players and can have significant economic affects on the revenue realized by a course.

Another disadvantage of electronic ranging systems is that their use is prohibited by the U.S. Golf Association. This severely limits the use of such systems.

### SUMMARY OF THE INVENTION

The above-discussed and other disadvantages and failings of previously proposed devices and systems for providing information to a golfer are surmounted by the present invention. That invention constitutes a programmed device which can be used by a golfer, while on a golf course, to track the golfer's play by using a single-entry recordkeeping system. For the sake of convenience, this device is hereinafter most often referred to as a GolfWits device.

The GolfWits device can be hand-held or mounted to a golf cart or golf bag.

Each play of the ball is recorded by pointing on a touch screen to a graphic display of a course fairway to position the ball on the course, then entering information about how the ball was played. GolfWits displays the yardage between two points, the right club to use, the flight of the ball, the number of fairways hit, and the number of putts. Also, reference to the golfer's personal history of games played in the past, statistical data, etc., is available. The golfer may upload this data to a personal computer (“PC”) and display the information in a large-scale format or manipulate the data and print out information of interest.

In the interest of providing a golfer with the simplest possible data entry format, the GolfWits device uses graphic images of the course; and the golfer simply points to ball positions on the course. Three kinds of graphics images are available:

1. A generic course fairway. This image is displayed for golf courses that are currently not in a course resources database.

2. A customizable golf course. This image is modifiable by the golfer—for example, choosing water, sand, fairway, and other hazards and positioning them on the screen in the configuration that best matches the hole being played.

3. A reproduced course layout made for a specific golf course.

GolfWits has a very simple interface for tracking the way the golfer plays the ball around the course. The interface is made up of three elements: Viewer, IconBar, and Dialogs. The golfer interacts with these three elements to record his/her play.

Viewer

The viewer displays generic, customizable, and specific course layouts, individual holes, scorecard information, charts, and statistical reports. It also interacts with the user by displaying popups with specific information as the user moves the pointing device around the viewer.

IconBar

The icons found on the IconBar launch dialogs and screen layouts.

Dialogs

Dialogs display both auto-acquired and requested data. Dialog boxes are used to get and confirm information from Tee, Ball, Positioning, Putting, and About boxes.

GolfWits provides details akin to those available from a conventional golf scorecard including: score, handicap, yardage grid, local rules, course specifics, and graphic hole layouts. Golf Course Standard Data can be downloaded from a central computer or an Internet site containing Golf Course maps compatible with the software. The software can calculate distances and the time of play for each hole, provide course information, and club selections, and calculate statistical data based on user selection, all without employing GPS, radio, or any other communication with a second device. The GolfWits software can also display course comments by golf professionals. The software further provides a routine for storing user data, for historical statistics, and for uploading data to a central computer or server.

GolfWits is, in short, a portable computer system for recording and analyzing stroke data and providing a means to calculate distances from and to any point on the hole layout. It is capable of:

A. Displaying a course scorecard and hole layouts activated by the user from which a user's current score and location on a hole layout can be determined and displayed without the need for GPS, radio, or any other communication link to a second device;

B. Providing course scorecard information which includes a scoring grid with yards, par, and handicaps for each hole along with space to record personal scores, accuracy, strokes in regulation and/or in fairways, putts, and strokes over par;

C. Providing course layouts which include hole layouts and surrounding course features for an unlimited number of courses;

D. Providing the user's current location based on user selection of hole layout, calculating distances from tees or previous points to a user's selected point and from the user's selected point to the pin or any other point of the user's choosing;

E. Providing the location of the ball in the fairway, on the green, in the rough, in the water, in a bunker, in an adjoining fairway, or out-of-bounds;

F. Recording club usage and the flight path of the ball;

G. Automatically incrementing the number of strokes based on ball settings;

H. Providing the ability to preplay, replay, or view any hole layout while on or off the course;

I. Providing the ability to view the statistics of a round of golf or multiple rounds of golf in charts and tables; and

J. Providing the ability to view the hole layouts with each recorded stroke on each hole.

The objects, advantages, and features of the present invention will be apparent to the reader from the foregoing and the appended claims and as the ensuing detailed description proceeds in conjunction with the accompanying drawings.

### BRIEF DESCRIPTION OF THE DRAWINGS

In the drawings, like reference numerals refer to like parts throughout the various views unless indicated otherwise.

FIG. 1 is a pictorial view of a hand-held device embodying the principles of the present invention;

FIG. 2 is a pictorial view of an initial menu which appears on the display screen of the hand-held device;

FIG. 3 represents a second level menu which appears on the screen when the appropriate choice is made from the initial menu; the second level menu lists golf courses on which information is available;

FIG. 4 is a flow diagram of steps undertaken to configure the FIG. 1 device for a particular golf course and a particular golfer;

FIG. 5 shows an expanded menu which appears upon a course being selected from those listed in the FIG. 3 menu;

FIG. 6 depicts a scorecard which appears on the display of the FIG. 1 device when a SCORECARD option is selected from the FIG. 5 menu;

FIG. 7 depicts a golfer profile that appears on the display of the FIG. 1 device when a PROFILE option is selected from the FIG. 5 menu;

FIGS. 8 and 9 show representative, completed golfer profiles;

FIG. 10 is a view of the FIG. 6 scorecard, in this case populated for four golfers;

FIG. 11 is a flow diagram showing what happens when a user selects a cell of the populated, FIG. 10 scorecard;

FIG. 12 depicts a representative layout that appears when a golfer makes a selection from the FIG. 10 scorecard, in this case a layout of hole one of a golf course selected from the FIG. 3 menu;

FIG. 13 depicts an editable display which appears when a user of the FIG. 1 device selects a TEE option from the FIG. 5 menu;

FIG. 14 shows a golfer in the process of hitting a ball from the tee of a hole being played;

FIG. 15 is a flow diagram of what occurs when FIG. 14 golfer walks to the location where his ball came to rest from the tee shot and marks the location of the ball on the FIG. 12 display of the hole being played;

FIG. 16 shows how the FIG. 12 layout might appear after the position of the tee shot has been entered; included is data such as the remaining distance to the pin and the recommended club for the second shot;

FIG. 17 shows a Ball Position display which appears when the golfer selects a BALL option from the FIG. 5 menu;

FIG. 18 shows the FIG. 17 Ball Position display with the information added by the golfer;

FIG. 19 shows the FIG. 12 hole layout updated to show the flight of the ball from the tee and the golfer's score;

FIG. 20 shows the FIG. 19 version of the hole layout again updated to now show the position of the ball after the ball has been hit from the tee, the flight of the ball, the remaining distance to the pin, and the recommended club for the second shot;

FIG. 21 shows the golf course layout enabled by the golfer to show the distance to a hazard and to a spot the golfer wishes to reach to avoid the hazard, as well as the distance from the targeted spot to the pin;

FIG. 22 shows the golfer in the process of making his second shot;

FIG. 23 is a view of the hole one layout updated, typically by the golfer walking to the point where the ball has landed after the golfer's second shot and entering that position in the FIG. 1 device;

FIG. 24 shows the Ball Position dialog box edited to include data on the golfer's second shot;

FIG. 25 shows the thereupon updated layout for the hole being played along with data such as the number of strokes thus far taken by the golfer;

FIG. 26 shows a Putts display which is selected from the FIG. 5 menu and used by the golfer to record the number of putts taken on the hole being played;

FIG. 27 shows the FIG. 6 scorecard updated to include the golfer's play of hole one;

FIG. 28 shows the golfer in the process of entering into the FIG. 1 device data representing the play of hole one by his golfing companions;

FIG. 29 shows the scorecard with a tab named Hal selected so that data on that golfer's play can be entered;

FIGS. 30 and 31 show the scorecard in the process of being edited to incorporate the data on the play of golfer Hal; in FIG. 31 the number of putts taken by golfer Hal has been entered using a numerical keypad with digits zero through nine;

FIG. 32 shows the scorecard with the tab group selected to generate a leader board for the foursome playing the course (Kent, Hal, Roger, and Suzanne);

FIG. 33 shows how the leader board might look after completion of five holes;

FIG. 34 depicts a statistical analysis of the foursome's play; this analysis is brought up by selecting STATISTICS from the FIG. 5 menu;

FIG. 35 shows how the scorecard might appear after five holes if the foursome were playing golf games supported by the FIG. 1 device—in this case, skins and bingo-bango-bongo;

FIG. 36 shows the scorecard scrolled down to display a golfer's—in this case Kent's—score for the completed round of golf;

FIG. 37 depicts the scorecard with the golfer Kent's handicap represented by solid dots in the cells of those holes where a stroke is to be given to this golfer; and

FIG. 38 shows the scorecard with targets superimposed on the layout of the hole; the FIG. 1 device calculates and shows how close the golfer came to his/her target(s).

### DETAILED DESCRIPTION OF THE INVENTION

GolfWits software is loaded onto a PDA (Personal Digital Assistant) or other small, portable, programmable, typically hand-holdable or golf cart-mountable computer to provide what is herein referred to as a GolfWits device. GolfWits software can be written to run on a Windows CE/NT/9X, Palm, or other operating system.

FIG. 1 depicts one of many devices with a touch screen 79 which may embody the principles of the invention. This device is identified by reference character 80. FIG. 1 is not intended to depict a dedicated piece of hardware.

How the GolfWits device 80 is employed for its intended purpose is described below.

The user connects GolfWits device 80 to a PC (personal computer)(not shown) by way of the computer's serial port. He then connects to an Internet site and downloads the maps for the courses the user is going to play. The user then copies the course map the user wishes to play from the PC to GolfWits device 80.

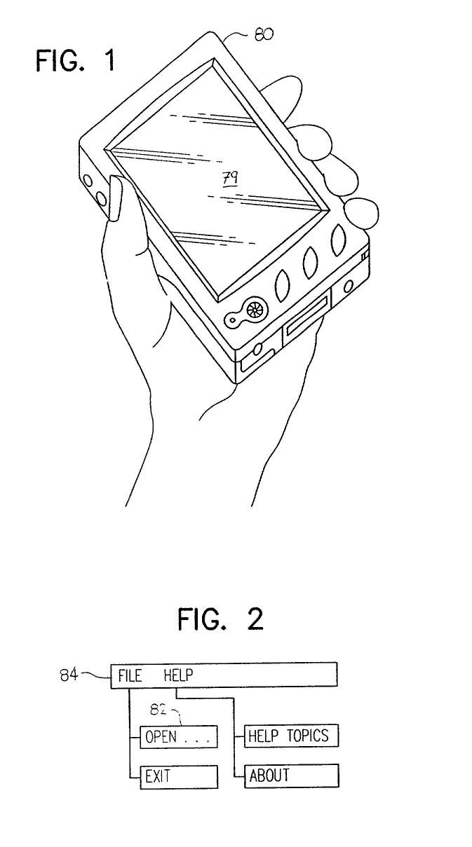

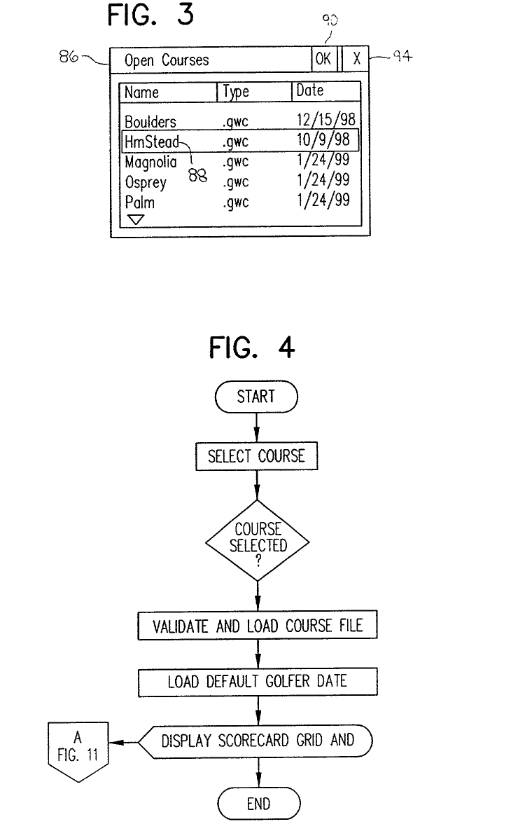

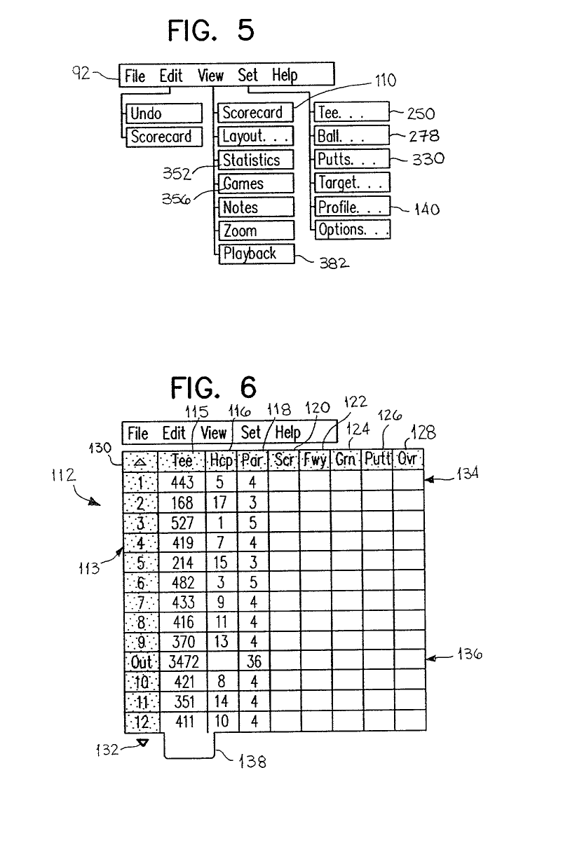

At the golf course and with the device in the user's hand (FIG. 1), the user selects OPEN choice 82 from the File Menu 84 shown in FIG. 2, bringing up the OPEN COURSES menu 86 of FIG. 3. From the OPEN COURSES menu, the user selects the course 88 he is going to play and presses OK button 90, causing the steps shown in FIG. 4 to be taken to bring up the expanded menu 92 of FIG. 5. Alternatively, if the golfer changes his mind, he can press button 94 to cancel his choice.

In a representative scenario, the user selects SCORECARD option 110 from the FIG. 5 menu 92. This puts GolfWits device 80 in the scorecard view mode 112 (FIG. 6). The scorecard headings are as follows: 113 is the hole number; 115 (Tee) shows the yards from a tee to the center of the green for a hole (by default the yards from the furthest tees are displayed): 116 is the handicap for the hole; 118 is par for the hole; 120 is the golfer's score; 122 is a drive found in a fairway; 124 is a green hit in regulation; 126 is the number of putts; and 128 is the number of strokes over par. Reference characters 130 and 132 identify scroll buttons that can be selected to scroll the rows of the FIG. 6 scorecard up and down respectively. Reference character 134 indicates the row containing data for hole number 1. Row 136 (out) contains the totals for holes 1 through 9. Reference character 138 identifies a ply tab which is blank until the golfer enters his/her name or multiple golfer names in which case more ply tabs are added.

From menu 92, the user chooses Profile (see reference character 140, FIG. 5).

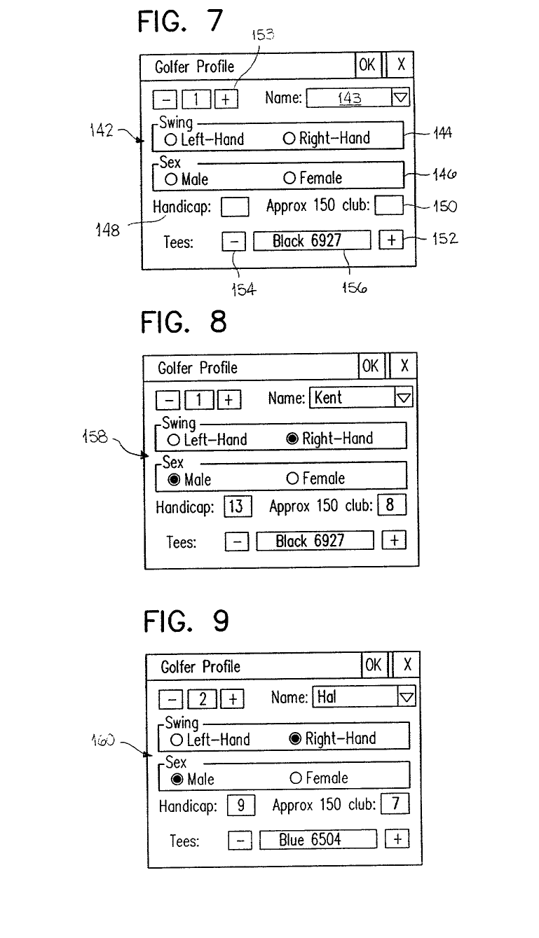

A Golfer Profile dialog 142 then appears (FIG. 7). The user enters or selects a golfer name in the Name box 143. He then fills in the Swing entry 144 and enters the player's sex in box 146. The user then enters the player's handicap 148 and, in box 150, the number of the club with which the player hits a ball 150 yards. He then enters the tees he wishes to play from by using the plus and minus buttons 152 and 154 to make selections from list 156. The user can also select the plus sign 153 to bring up a blank profile in order to make entries for a second golfer (up to 4 golfers can be accommodated).

FIGS. 8 and 9 show GOLFER PROFILE dialog boxes 158 and 160 with exemplary entries.

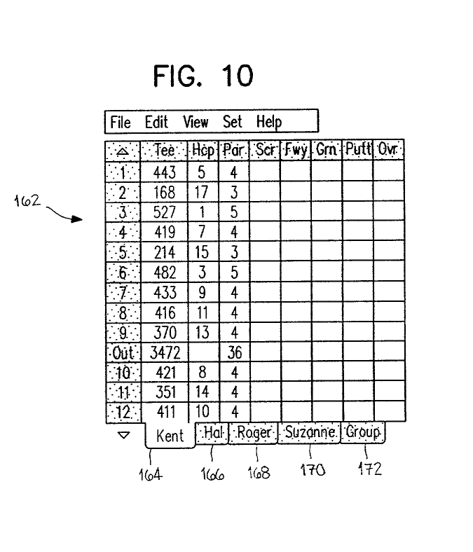

The result of completing the FIG. 8 and FIG. 9 dialog boxes 158 and 160 (and two others which are not shown) is a scorecard 162 with golfer ply tabs 164, 166, 168 and 170 populated for four golfers Kent, Hal, Roger and Suzanne (FIG. 10) and a group ply tab 172.

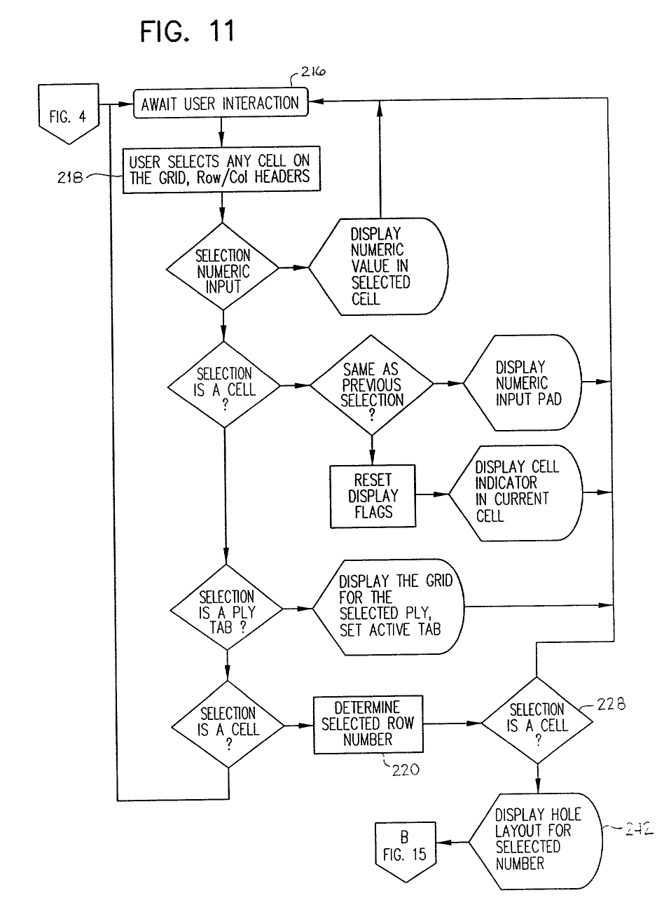

FIG. 11 shows a flow diagram of the GolfWits device 80 operations from the point in time in which the GolfWits device is waiting for the golfer to make a selection box (216).

Continuing with FIG. 11, if the golfer selects a point on GolfWits device screen 79 with scorecard 162 displayed other than a menu item, the GolfWits software determines what selection has been made. For example, if the selection 218 is a Row header, the GolfWits software determines which row 220 was selected and checks (at 228) to see if that row represents a hole number. If the row does represent a hole number, GolfWits device 80, as shown by reference character 242, displays the hole layout for that number.

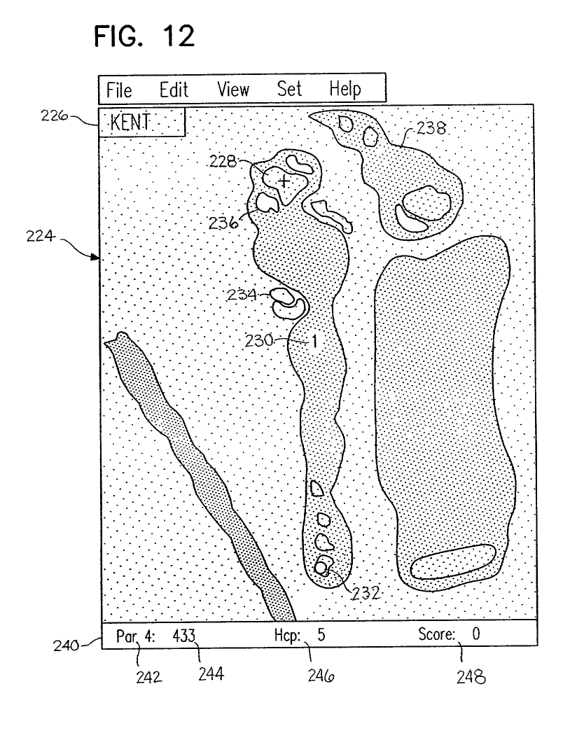

For example, if the user selects Row 1 (any row can be selected in any order), the layout 224 for hole one appears (FIG. 12). The golfer's name appears in the top left corner of the layout at 226. This helps to identify which golfer's display is being used. Each of the four golfers may keep his/her score using a hole layout which will record their score and the way they played the hole.

In FIG. 12, reference character 228 identifies the green. Reference character 230 indicates the hole number, and reference character 232 is the location of the tee for the golfer. This can be adjusted by selecting the ball and moving it to the appropriate position.

Reference character 234 identifies an exemplary sand trap, and 236 is an example of a green side bunker. Reference character 238 identifies additional details surrounding the current hole, like other nearby fairways. Reference character 240 identifies the status bar for the hole layout. The status bar shows a variety of data; viz., the par 242 and the total distance 244 from tee to flag. The handicap for the hole is 246, and 248 shows the current score for the golfer on the hole.

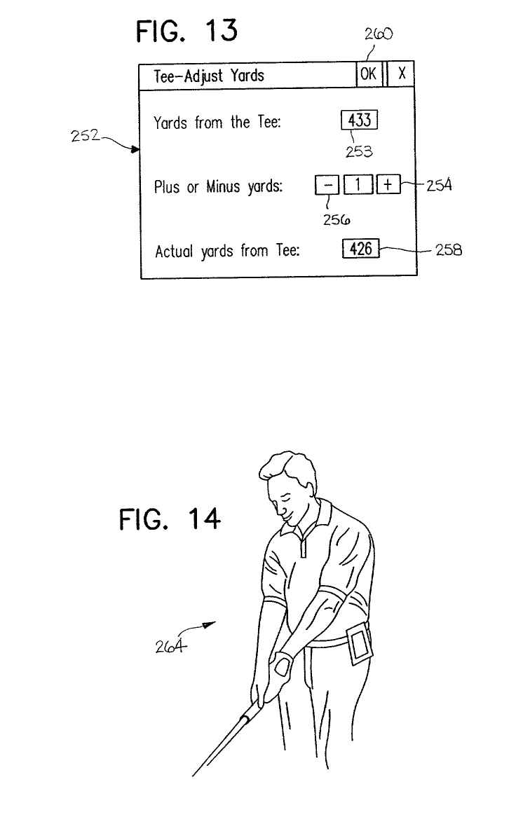

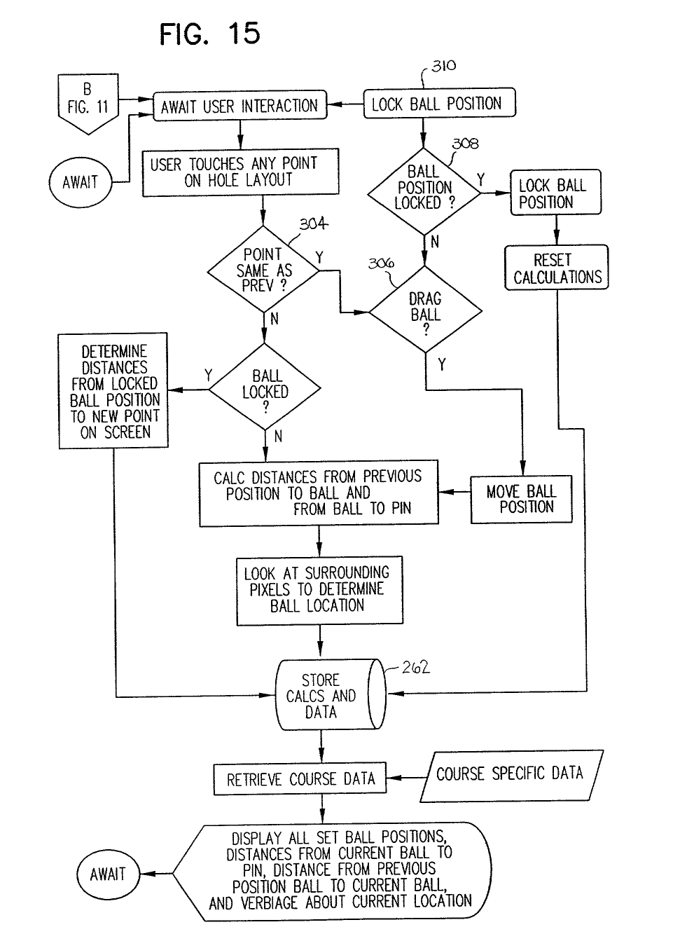

At this point the golfer selects TEE option 250 from Menu 92 (FIG. 5); and Tee Adjustment dialog box 252 appears (FIG. 13). In this figure, reference character 252 shows the default distance from the tee selected. The plus and minus buttons 254 and 256 allow the golfer to increment or decrement the yards from the default tee to provide the number of yards from the actual tee location to the flag in box 258. The golfer then selects OK button 260 to continue. The tee-to-green for this hole is stored in memory 262 (FIG. 15).

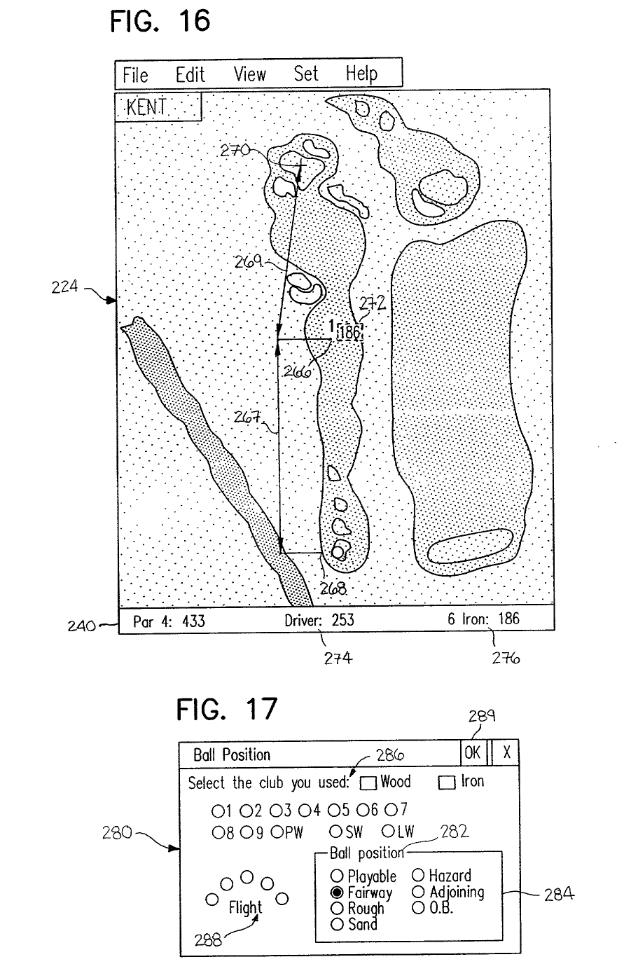

The golfer 264 tees up his/her ball and makes a shot (FIG. 14). The golfer now walks out to the ball and selects a point on the screen 79 that best represents the position 266 of the ball on the hole layout 224 (FIG. 16). If the selected point is new and the point was not locked by a second click, the GolfWits software calculates the distance 267 from the previous position 268 to ball position 266 and the distance 269 from the ball position 266 to pin 270. Then, the ball location is displayed as a dotted rectangle 272 containing the distance from the ball to the pin 270. Status bar 240 now displays at 274 the club used to hit the ball that distance 267 and, at 276, the suggested club for the second shot.

Golfer 264 next selects BALL option 278 from Menu 92 (FIG. 5), and Ball Position dialog 280 appears (FIG. 17). The ball position 282 is determined automatically by the GolfWits software. The user can change this selected location if he/she wishes by pointing to another option in box 284; and the golfer can point to screen 79 to enter the club used for the first shot at 286 and/or identify the flight of the ball by pointing to one of the flight paths such as 288.

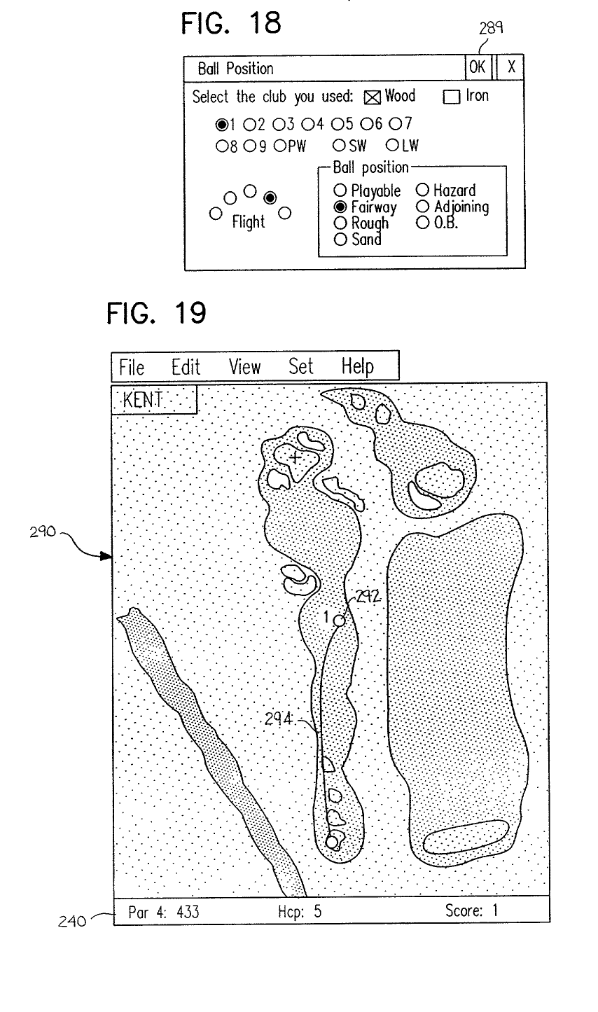

FIG. 18 shows the selections made by the golfer. Now the golfer selects OK button 289 to continue.

Pushing the OK button brings up on screen 79 an updated layout 290 (FIG. 19). The ball position rectangle 16 has been updated to a ball 292, and the flight path 294 of the ball has been drawn. The golfer's score is updated on status bar 240.

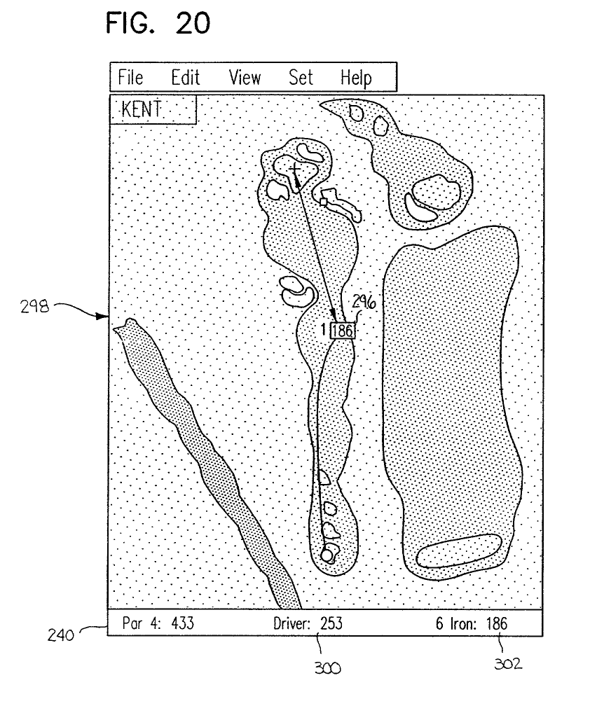

The golfer now selects the ball position again to determine how much further he has to go to the flag. Club selection and distance rectangle 296 appear (FIG. 20) on the hole one layout 298. The status bar 240 displays information on the previous shot at 300 and the new distance 302 from the current ball position to the hole one flag.

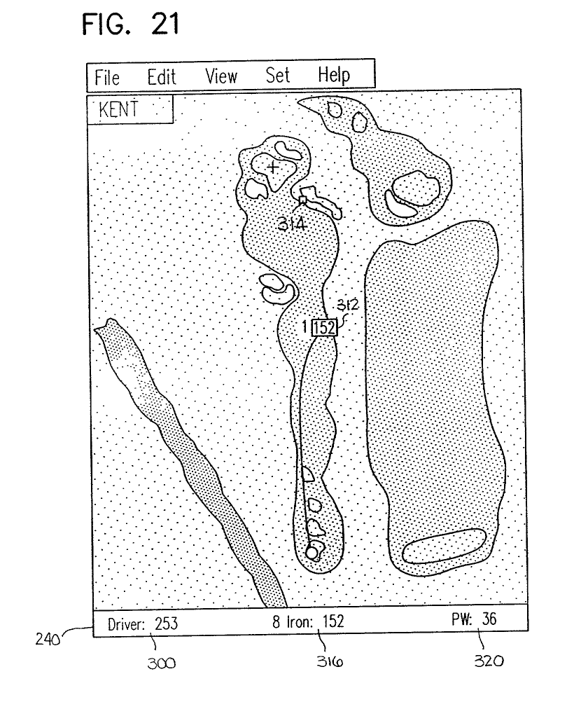

If the golfer selects the same point 282 a second time, the position is locked—see 304, 306, 308, and 310 (FIG. 15). This causes a solid line box 312 to appear in the updated hole one layout of FIG. 21. The golfer can select any other point, for example point 314, to appear on screen 79. The GolfWits software calculates the distance between the locked-in point 282 and the new point 314. The status bar 240 now displays the first shot club and distance data 300, the suggested club for the new distance (reference character 316); and the suggested club for the distance from the last point to the hole one pin 320.

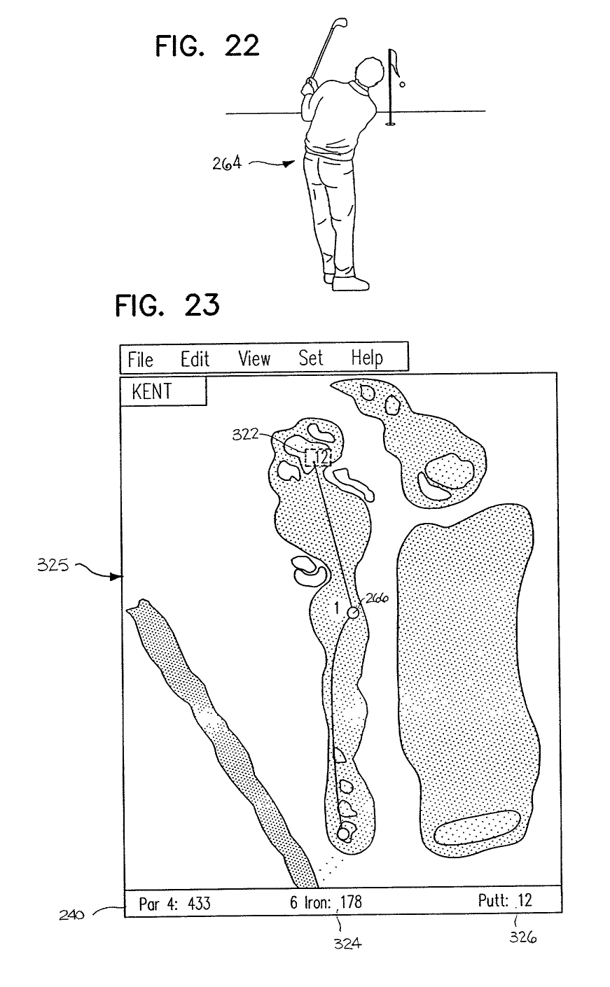

The golfer 264 makes his/her second shot (FIG. 22) based on the information given by the GolfWits device 80 (FIG. 1). The golfer walks up to the ball after the shot and makes a reasonable estimation as to where on the updated layout 325 of hole one his/her ball is (FIG. 23). The remaining distance to the pin is displayed in a dotted rectangle 322. The distance from the previous position 266 and the club used for that shot are displayed in the status bar 240 at reference numeral 324. The club selection for the next shot and the distance to the pin are displayed in the status bar at 326.

The golfer selects the BALL POSITION option 278 from the Menu 92 (FIG. 5). The golfer enters club and flight data for the second shot in the “Ball Position” dialog box 280 (FIG. 24).

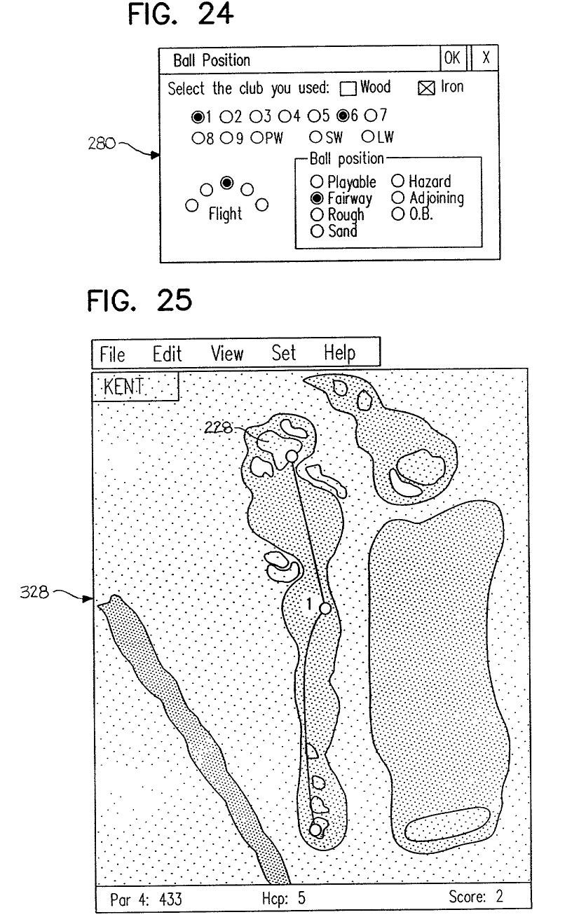

FIG. 25 shows the layout 328 for hole one as then updated by the GolfWits software.

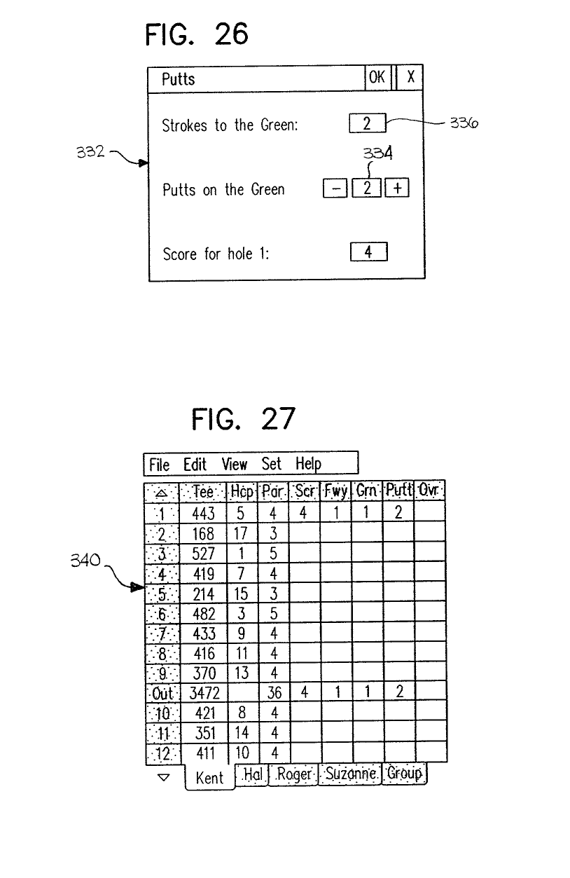

With his/her second shot, the golfer has reached the green 228 of hole one. The golfer therefore selects PUTTS option 330 from Menu 92 (FIG. 5). The “Putts” dialog box 332 is brought up (FIG. 26), and the golfer enters the number of putts taken on the green in box 334. The strokes from tee to green are calculated by the GolfWits software and displayed in box 336.

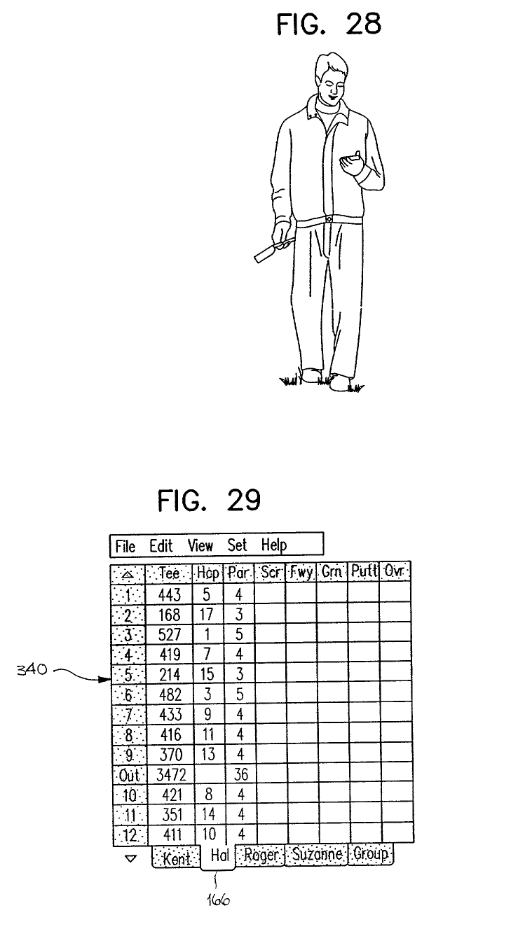

When hole one has been completed, the user can view his/her score by selecting the SCORECARD option 110 from Menu 92. What the golfer sees is an updated scorecard 340 (FIG. 27). With the updating having been done automatically by the GolfWits software, the golfer 264 can now also enter the scores of the other players (see FIG. 28). It is possible to record the same information for all the golfers at any time during play; it is not recommended that one golfer keep score this way, but it is possible if time permits.

The golfer selects the ply tab 166 of the next golfer (Hal). The scorecards as updated and identified by reference character 340 in FIG. 29 will now display the data for golfer Hal.

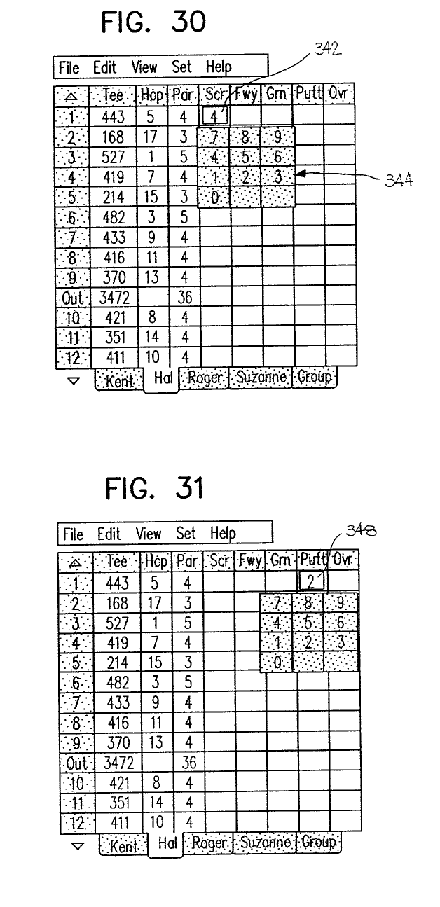

The golfer selects the cell 342 in column (Scr. 1, FIG. 30) which accepts golfer Hal's score for hole one. Upon selecting this same cell a second time a numeric input pad 344 appears, and an edit window (not shown) is opened for cell 342. The golfer can select any number on the pad, and it will appear in the selected cell 342. The golfer can now select the cell 348 (Putt 1) that represents the number of putts taken by Hal on the first hole (see FIG. 31) and perform the same steps that were utilized in entering the total hole score to record the number of Hal's putts on hole one.

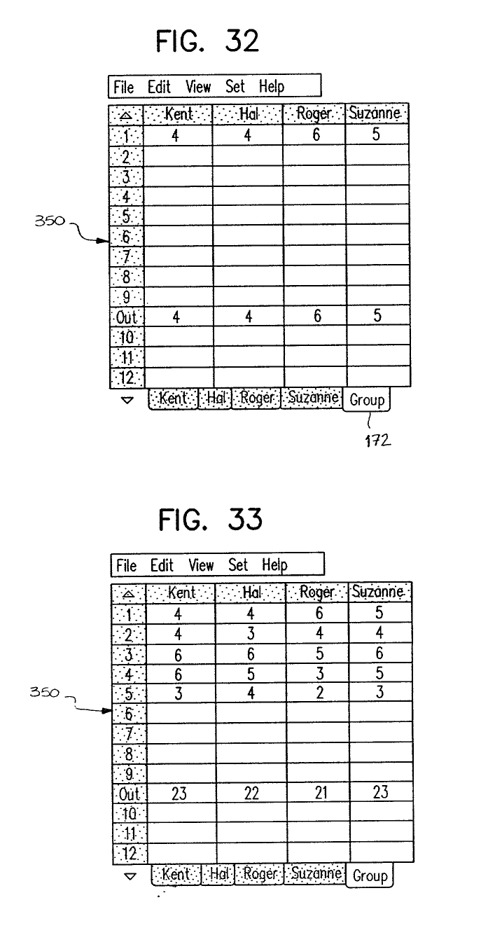

These steps can be repeated for each golfer. Then, the golfer can select the ply tab “group” 172 to view a leader board 350 (FIG. 32) for the group. After five holes have been completed the leader board 350 might appear as shown in FIG. 33.

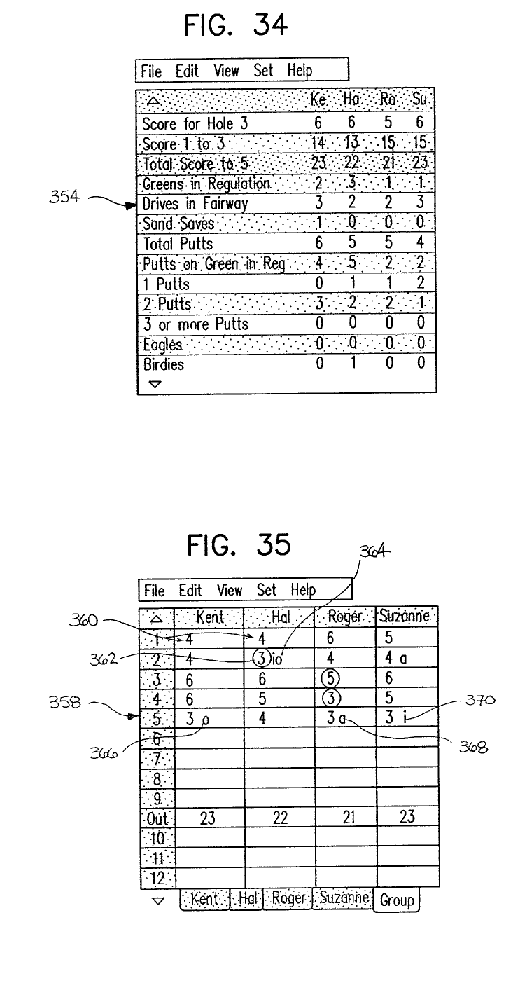

The golfer can view the statistics of his play by selecting the STATISTICS option 352 from Menu 92 (FIG. 5). The representative “Statistics” display 354 of FIG. 34 will appear.

If the golfer has elected to play a golf game by selecting the GAMES option 356 from Menu 92 (FIG. 5), the golfer can also view the status of the games that are being played on the Group Scoreboard as shown in FIG. 35 and identified by reference character 358. Thus, reference character 360 depicts a skins carryover; and reference character 362 depicts a skin that is won by the circle. Reference character 364 depicts a game of Bingo-Bango-Bongo, where one golfer has won the Bingo and Bongo. Reference character 366 represents Bingo, reference character 368 represents Bango, and the reference character 370 represents Bongo. The definitions of these terms are as follows: Bingo—First on the green; Bango—Closest to the hole after the second shot; Bongo—First in the cup.

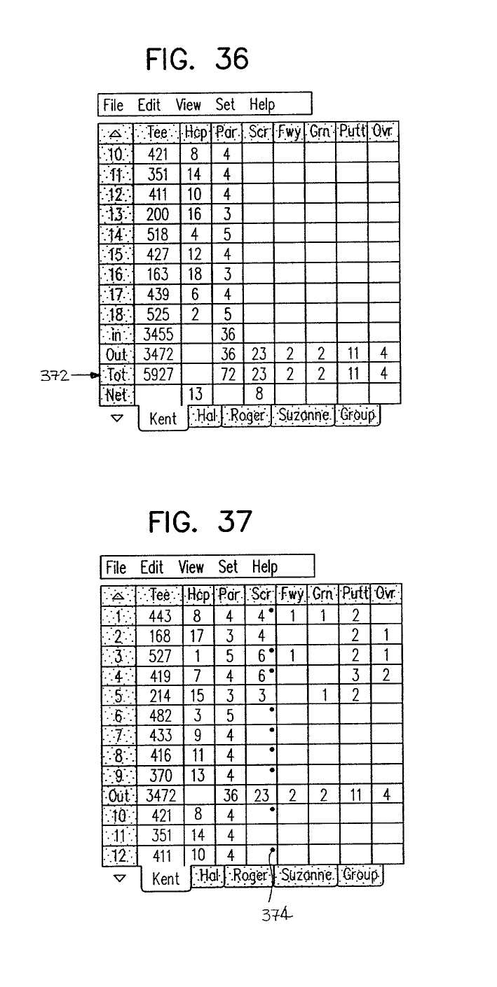

The golfer can then view the statistics for his/her 18 hole game by scrolling to the bottom row 372 of the scorecard (FIG. 36).

The golfer can view his/her handicap by counting the dots 374 on the scorecard (FIG. 37). If a golfer's handicap were 13, there would be 13 dots in the cells under the column heading Scr (Score). Each dot 374 represents a stroke given to the golfer and subtracted from his/her net total score to get a net score. (FIG. 36).

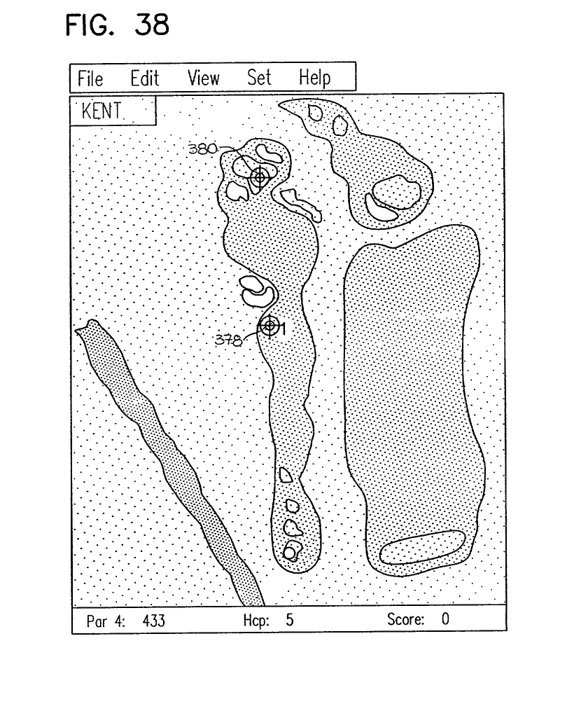

The golfer can also set targets on a hole layout (FIG. 38). Those targets are used to show how accurate his/her strokes are. The targets for representative hole one are identified by reference characters 378 and 380. Then the golfer plays each hole and selects the position that best represents the location where the golfer's ball landed. The GolfWits software then calculates whether or not the golfer hit his/her target based on the acceptable distance that was set by the GolfWits user. If the target is missed, one of four characterizations of the shot may appear: (1) short; (2) long; (3) right; or (4) left.

As set forth in the summary of the invention, the GolfWits device is capable of displaying customizable course layouts, individual holes, scorecard information, charts, and statistical reports. Specifically, the GolfWits software allows a golfer to customize the statistical data input into and retrieved from the GolfWits device. Specifically, a formula parser inside the GolfWits device allows the golfer to write customizable formulas relating to the statistics of a golfer's play. It should be noted that the formula parser may be a stand-alone parser or may be incorporated into the GolfWits device or software.

In use, the golfer may write a formula in a text file format. The formula may be written using the GolfWits device, other handheld device, or an external computer. The format that may be followed is a dual column format, in which each column is separated by commas and each column is enclosed in quotes. It is preferred that there be only two columns per row so that a formula may be written and easily viewed on the GolfWits device or other handheld device.

To activate a customized formula previously entered by a golfer, the golfer may select the CUSTOM option from the Menu and select a particular customized formula he wishes computed. When the formula is selected, a formula parser activates and searches the GolfWits software for the existence of a “personal” formula file with the formula therein. If the “personal” file is found, the formula parser opens the file, reads a desired formula into memory, runs the appropriate programs so that a desired formula is calculated, and stores the calculated values until the results appear on the STATISTICS screen of the Golfwits device.

For example, if a golfer desires to know the percentage of golf shots that the golfer sliced, the golfer may enter a statistical formula that calculates the percentage of golf shots the golfer sliced. The resulting formula might be “%Slice,”=PERCENT(TOTAL(BALLPATH(HOLES(1-18), NUM(0), 0)), SUB(TOTAL(SCORE(HOLES(1018))), TOTAL(PUTTS(HOLES(1-18),10))), 2)”. In another example, a golfer desiring to know the number of par 3 holes in an 18 hole golf course may enter a statistical formula that displays the number of par 3 holes on an 18 hole golf course. The resulting formula might be “Par 3s found in holes 1-18”, “=PAR(HOLES(1-18), 3)”,.

After the round of golf is completed and the scores have been entered, the golfer may review the round by selecting the PLAYBACK option 382 from the Menu 92 (FIG. 5). Every stroke placed on each hole layout will be cleared and replayed. A simulated ball will follow the recorded flight path. The user can thereby get a unique feel for how well he/she played.

While the invention is described and illustrated here with respect to a particular embodiment, the invention may be embodied in many forms without departing from the spirit or essential characteristics of the invention. The present embodiment is therefore to be considered in all respects as illustrative and not restrictive. The scope of the invention is indicated by the appended claims rather than by the foregoing description, and all changes which come within the meaning and range of equivalency of the claims are intended to be embraced therein.

What is claimed is:

1. A self-contained, mobile instrumentality for storing and making available information on a game of golf, said instrumentality comprising:
memory for storing the layout of a golf course hole to be played which has been downloaded from the internet;
memory for storing data representing the hole-by-hole play of a golf course by a particular individual; and
a display comprising a touch screen activatable by a user of said instrumentality to input data to and retrieve information from said memory and to view said information;
said memory capable of storing a retrievable and viewable layout of a golf course hole;
said user can input data to said memory by touching said screen at a location on said layout corresponding to the position of a ball on the course being played;
said instrumentality capable of calculating from the inputted ball location for display to said user the distance to a flag or other feature of a hole being played.

4. An instrumentality as defined in claim 1 wherein:
said layout includes the distance for said hole; and
a user of the instrumentality can utilize said touch screen to modify the displayed distance to correspond to the actual tee and pin place on the course represented by said layout.

5. An instrumentality as defined in claim 1 which has the capability of compiling, for retrieval and display, a scorecard for said individual.

6. An instrumentality as defined in claim 2 wherein the scorecard contains data for each of a plurality of individuals.

7. An instrumentality as defined in claim 2 which:
visually presents the individual's handicap on the scorecard; and
automatically calculates the score for each hole to take any handicap appurtenant to that hole.

9. An instrumentality as defined in claim 1 which has the capability of storing a profile for said individual.

10. An instrumentality as defined in claim 1 which has the capability of accepting and storing golf course hole layouts transmitted to the instrumentality from a computer capable of downloading said courses from the Internet.

12. An instrumentality as defined in claim 1 which is hand-held.

13. An instrumentality as defined in claim 1 which is a programmable general purpose computer.

14. A method of making information available to a golfer, said method comprising the steps of:
providing a mobile, self-contained instrumentality with data storage, calculation, retrieval, and display capabilities;
downloading the layout of a golf course hole to be played from the Internet to a personal computer;
transferring the layout of said hole from the personal computer to the mobile, self-contained instrumentality;
storing the downloaded layout of a golf course hole in memory in the data storage element of the instrumentality;
retrieving from memory and displaying upon a command by said user a layout of said hole and/or information on playing of said hole by a golfer; and
said instrumentality capable of calculating the distance from a first location on said hole to a second location on said hole.

16. A method as defined in claim 14 which comprises the step of loading data constituting the layout of a golf course into said self-contained instrumentality.

17. A method as defined in claim 14 wherein the layout is one of a specific golf course.

18. A method as defined in claim 14 wherein the layout is one of a generic golf course.

19. A method as defined in claim 14 which includes the step of customizing a golf course layout stored in memory in said self-contained instrumentality.

20. A method as defined in claim 14 in which the layout is downloaded from the Internet.

21. A method as defined in claim 14 which includes the step of uploading data from said self-contained instrumentality to a computer.

22. A method as defined in claim 14 in which:
the location of a ball is provided by displaying the layout of the appropriate hole of the course being played and pointing to the location on said hole layout corresponding to that location where the ball actually rests; and
then calculating from the data supplied by the preceding step at least one of the following:
the distance the ball was hit to reach said location of the ball,
the distance to the flag of the hole being played,
the distance from the location of the ball to a selected feature of the hole,
the most appropriate club for the next stroke,
a suggested line of play for the next or remaining holes of the course.

23. A method as defined in claim 14 which includes the step of pointing to icons displayed by said instrumentality to retrieve information of specific character from memory.

24. A method as defined in claim 14 wherein:
it is the layout of a generic golf course that is stored in memory;
a user enters the distance from the tee to the green of a hole on a course being played:
said self-contained instrumentality is then employed to calculate and display data relevant to the playing of the actual hole.

25. The combination of: a portable, self-contained instrumentality for storing and making available information on a game of golf and a personal computer;
said portable, self-contained instrumentality comprising:
memory for storing data representing the hole-by-hole play of a golf course by a particular individual;
a display comprising a touch screen activatable by a user of said instrumentality to input data and retrieve information from said memory and to view said information;
said instrumentality capable of calculating the distance from a first location on said hole to a second location on said hole; and
said personal computer having elements for:
effecting a connection to the Internet; and
effecting a transfer of data to the portable, self-contained instrumentality; and
receiving and storing data received from said instrumentality.
